(19) United States
(12) Patent Application Publication
(10) Pub. No.: US 2001/0011280 A1
(43) Pub. Date: Aug. 2, 2001

(54) COMPUTER-BASED TRAINING SYSTEM

(76) Inventors: EDWARD S. GILBERT, NEW YORK, NY (US); JOSEPH C. KIEFFER, SHELTON, CT (US); GIULIANO J. CHICCO, KATONAH, NY (US)

Correspondence Address: CLIFFORD CHANCE ROGERS & WELLS LLP, 200 PARK AVENUE, NEW YORK, NY, 10166, US

(21) Appl. No.: 09/060,062

(22) Filed: Apr. 14, 1998

(51) Int. Cl. G06F 17/00

(52) U.S. Cl. 707/500

(57) ABSTRACT

A computer-based method for use in managing training of employees includes storing data that correlate employee characteristics with training requirements, obtaining information about employee characteristics through computer interaction with the employees; and determining training schedules by applying the obtained information to the stored data. The employee characteristics may include information such as job functions and experience. The method may translate the employee characteristics into risks that correspond to needed training.

### BACKGROUND OF THE INVENTION

This invention relates to computer-based training.

Computer-based training may be provided to individuals using interactive multimedia software to supplement or replace other modes of training. Effective training is important for aspects of jobs that entail high liability or damage risks. For example, a lending officer of a financial institution must be trained to comply with all applicable federal regulations. The timing, breadth, and effectiveness of such training may affect the risk.

### SUMMARY OF THE INVENTION

In general, in one aspect, the invention features a computer-based method for use in managing training of employees. The method includes storing data that correlate employee characteristics with training requirements, obtaining information about employee characteristics by computer interaction with the employees, and determining training schedules by applying the obtained information to the stored data.

Embodiments may include one or more of the following features. Computer interaction with employees may occur over a user interface. The computer interaction may include processing HTML and/or Java instructions. The computer may further provide interactive computer-based training as determined by the training schedule.

The computer may store training information that represents a level of required proficiency in a training session. The computer may also store the level of proficiency attained by an employee. The computer may further determine employee compliance with the determined training schedule.

In general, in another aspect, the invention features a computer-based method for use in managing training of employees whose job functions entail liability risks to their employer. The method includes storing data identifying types of the liability risks, storing data representing types of job functions that entail the associated risk, interactively obtaining information about the employees job functions, and managing training for the employees based on applying the interactively obtained information to the stored data.

Embodiments may include one or more of the following features. Managing training may include determining a training schedule, providing interactive computer-based training, and/or determining employee compliance with the determined training schedule. The types of risk may include antitrust liability, insider trading, and ethical business practices. The job functions may include, for example, pricing decisions and client contact.

Advantages of the invention may include one or more of the following. By interactively producing a tailored training schedule based on assessed training needs, a business can reduce its risk and liability. Additionally, compliance managers can quickly track the progress of employees through the training schedule. Further, by providing interactive computer-based training sessions, the system offers an integrated training system that identifies and provides the training needed by an employee at the employee's convenience.

Other advantages and features of the invention will become apparent from the following description and the claims.

### BRIEF DESCRIPTION OF THE DRAWINGS

FIG. 1 is a diagram of a computer-based training system.

FIG. 2 is a diagram of employee profile data.

FIG. 3 is a diagram of assessment data.

FIG. 4 is a flowchart of training assessment.

FIGS. 5A-5C are screenshots illustrating training assessment.

FIG. 6 is a flowchart of employee training.

FIG. 7 is a flowchart of compliance management.

FIG. 8 is a diagram of a computer platform suitable for running the training system.

FIG. 9 is a diagram of a networked training system.

### DESCRIPTION OF THE PREFERRED EMBODIMENTS

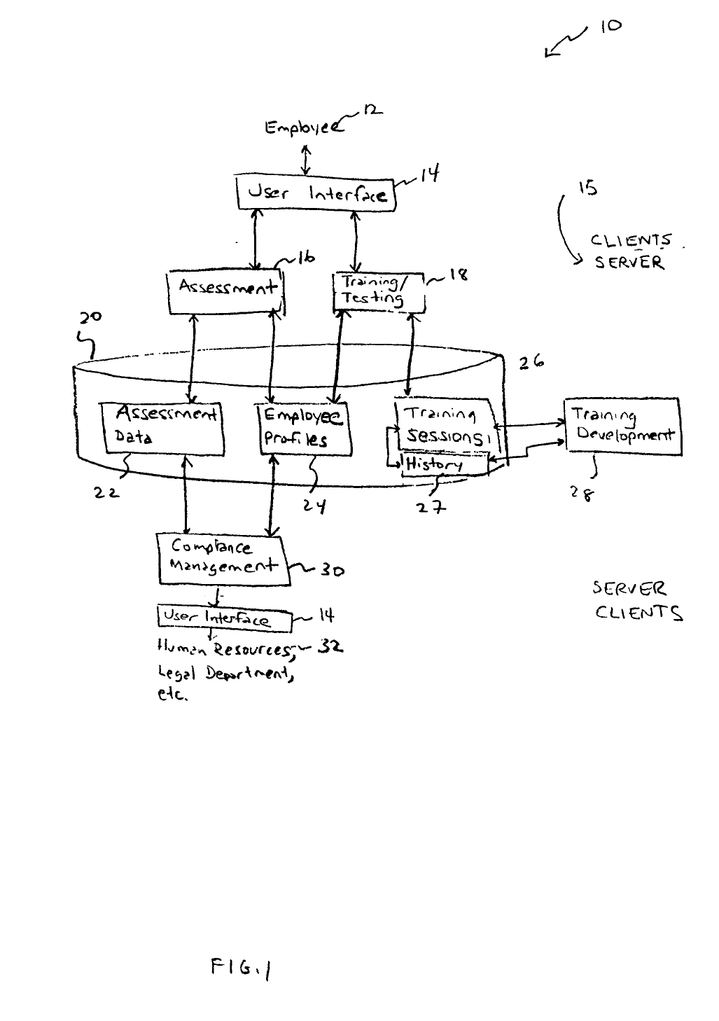

Referring to FIG. 1, a computer-based training system 10 includes training software 18 that interactively trains and tests employees 12 based on each employee's training needs as determined by assessment software 16. “Employee” is intended to be a broad term encompassing contractors, etc. The system 10 also includes compliance management software 30 that notifies management 32 (e.g., human resource and legal departments;) of an employee's 12 training progress. Integration of these functions provides training tailored for each employee 12 and ensures that employees undertake job training in a timely fashion.

The system 10 software modules 16, 18, 30 share access to a database 20, such as an Oracle® relational database. Other implementations may distribute the data across multiple databases residing a different locations. The database 20 stores employee profile data 24 and data used in assessing employee training needs 22. The database 20 also stores different training sessions 26 such as interactive multimedia presentations and question and answer scripts. Interactive training that provides immediate feedback based on trainee input has been shown to be more effective than more passive instructional media such as videotapes. Computer-based training sessions also can reduce the cost of training since a session can be repeated by different employees as many times as needed, when needed. Additionally, each employee can train at his or her own convenience and pace.

The database may also store historical data 27 collected during training sessions such as employee responses to different questions. Training development software 28 can compile reports from the historical data 27 that identifies strengths and weaknesses of different training sessions 26. For example, a training development 28 report might show statistical evidence of problems with a particular question indicating the tested material may require better presentation. Thus, the historical data 27 forms a feedback loop that improves training materials.

The system 10 uses a client/server architecture 15 and a graphical user interface 14 in the clients to present system training, assessment, and compliance information to different employees 12, 32. This architecture centralizes training information at the server, enabling training developers and compliance personnel to easily modify training sessions and track employee training progress.

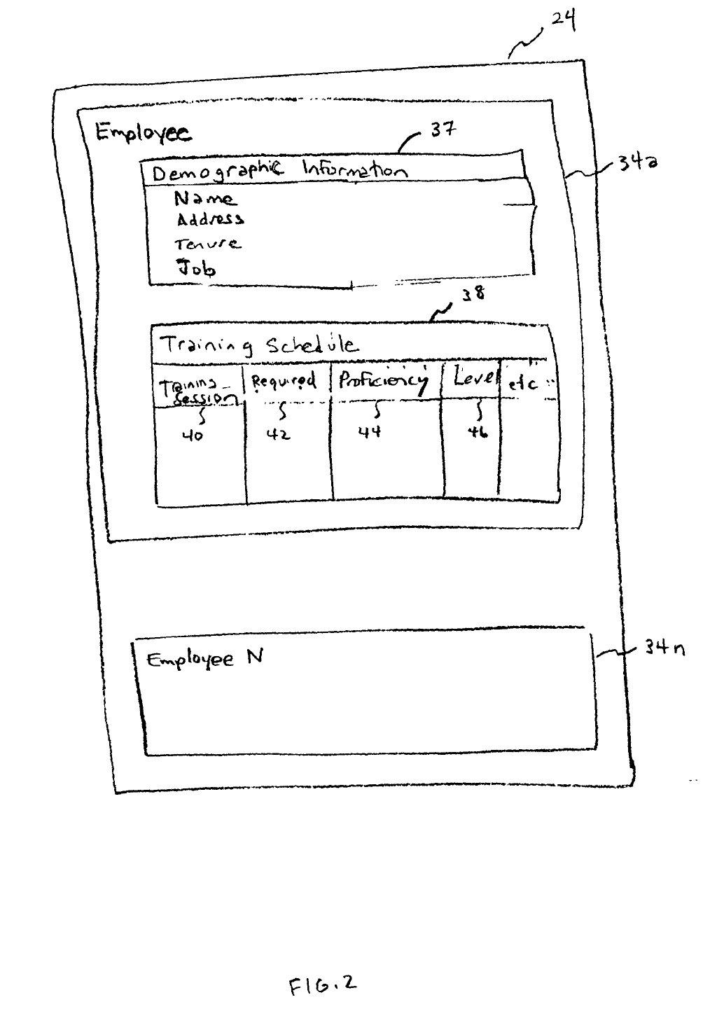

Referring to FIG. 2, employee profile tables 24 stored on the server include demographic information 37 and a training schedule 38 for each employee 34a-34n. Typically, the demographic information 37 includes data fields for an employee's name, address, job classification, length of tenure with a business, etc.. The training schedule 38 lists the different training sessions the assessment software 16 has identified as recommended or required for an employee. The training schedule 38 includes data fields that specify a training session identifier 40, whether a particular session is required or recommended 42, the proficiency 44 the employee has attained, and the level 46 of proficiency required by the employee's job. Both an employee and compliance managers can access an employee's profile to quickly gauge whether an employee requires additional training measures to attain proficiency in different job skills. For example, a training coordinator can identify employees having difficulty with a subject and schedule a live training seminar or prepare additional training materials.

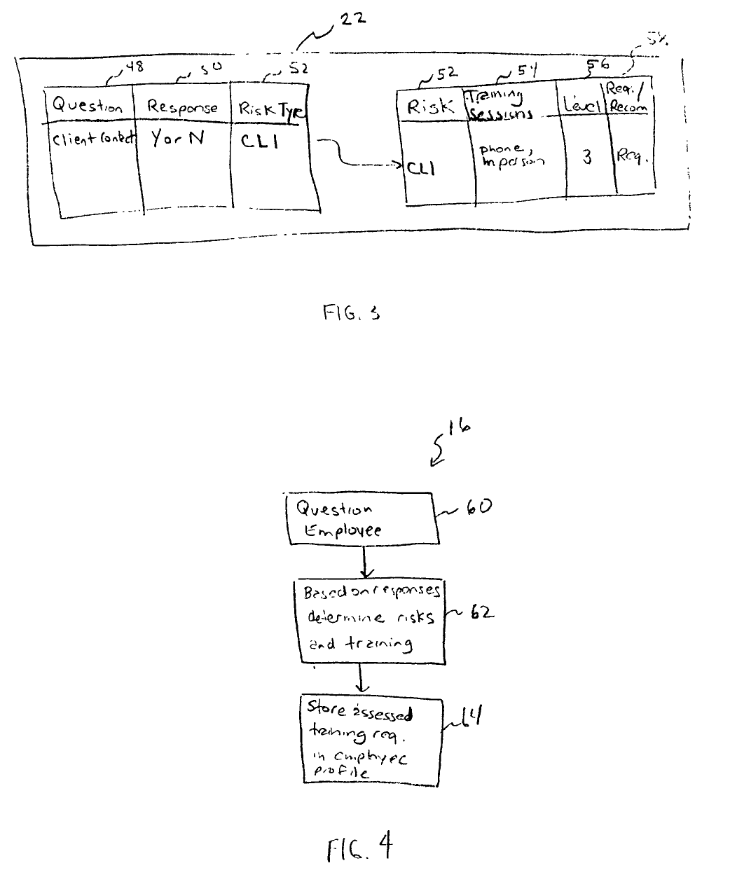

Referring to FIG. 3, assessment tables 22 store data used by assessment software 16 to determine the training an employee requires. The assessment tables 22 represent analysis of business processes and associated compliance risks. Assessment data 20 can include questions 48, possible responses 50, and the legal compliance risks 52 associated by different employee characteristics as indicated by employee responses. For example, an employee may be asked via user interface on the client whether her job entails pricing decisions. A positive response indicates the employee may require antitrust compliance training at a particular level in order to reduce the risk of an antitrust violation. Each risk type has an I.D. 52 associated with it. The risk I.D. 52 acts as an index into a training information table 58 that stores training session identifiers 54 that correspond to training sessions 26 directed toward eliminating a particular risk 52. The training information table 53 also stores a level of proficiency 56 required by the employee to adequately address a particular risk, and whether such training is recommended or required 58. For example, the employee making price decisions could benefit from training in antitrust topics such as price discrimination and predatory pricing.

Referring to FIG. 4, assessment software 16 questions employees regarding their job functions (60) and analyzes employees responses to determine (62) whether an employee requires training and what level of training the employee needs. Certain responses indicate heightened risk requiring training (e.g., access to sensitive information) while others may lessen the need for such training (e.g., several years experience with confidential materials).

Assessment may occur via web-based screen questionnaires. Such questionnaires may be pre-designed or constructed dynamically from assessment data 24. The assessment software 16 can also read an employee's profile to acquire information about the employee's experience and training needs. The assessment software 16 can also modify an employee's profile based on questionnaire responses. Based on data collected from the employee interactively and the employee's profile, the assessment software 16 can identify needed training. The assessment software 16 can update an employee's profile (64) to reflect the training sessions the employee should undertake.

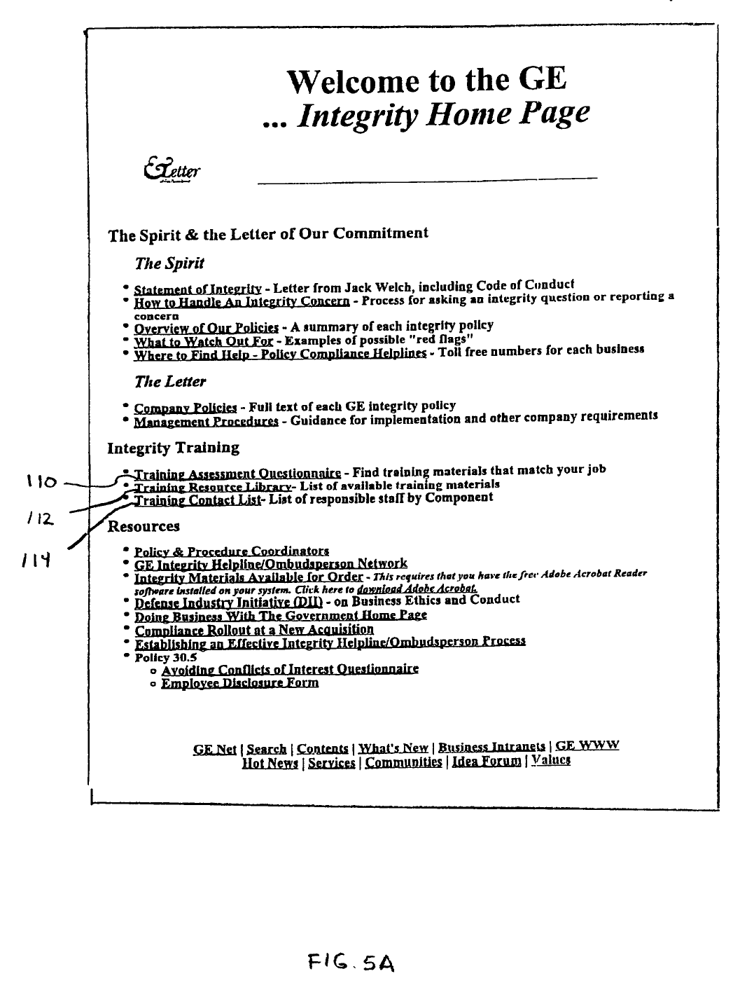

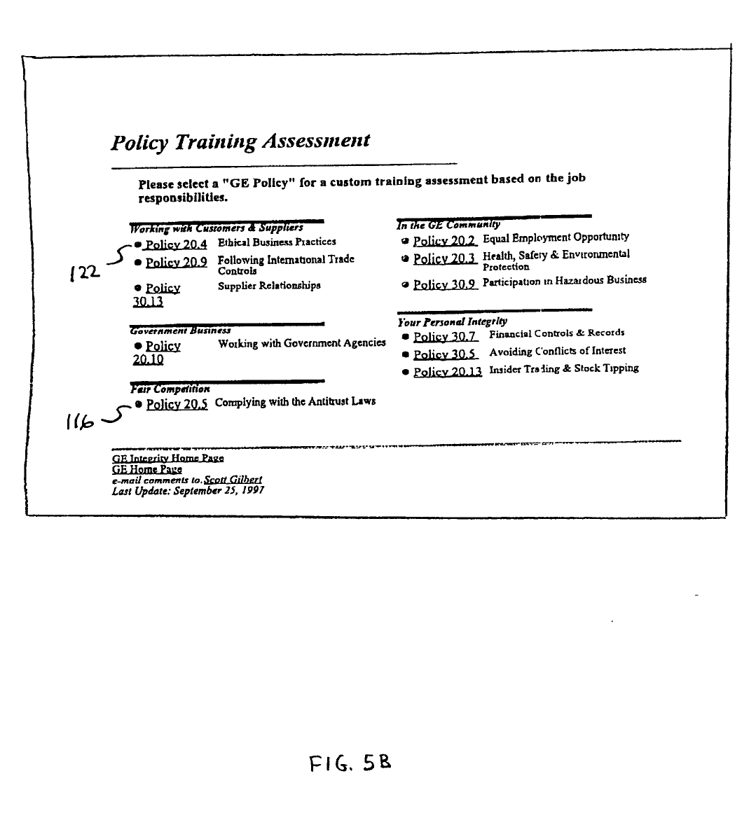

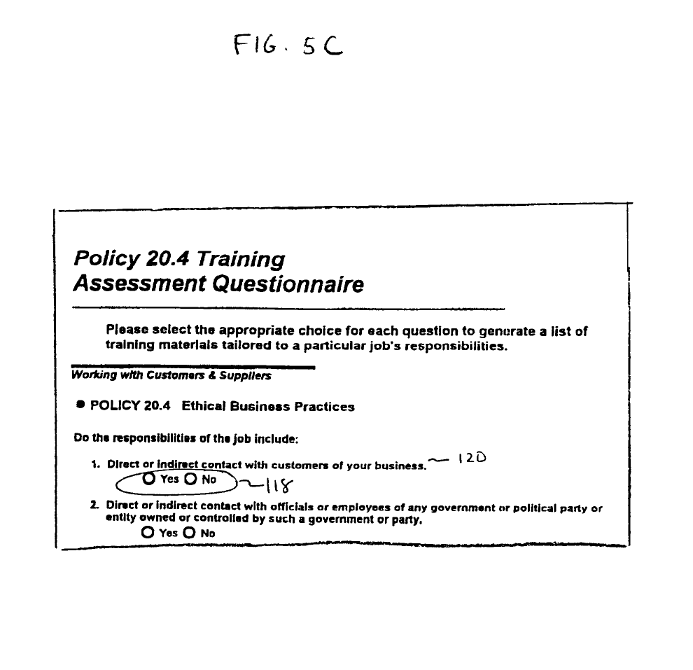

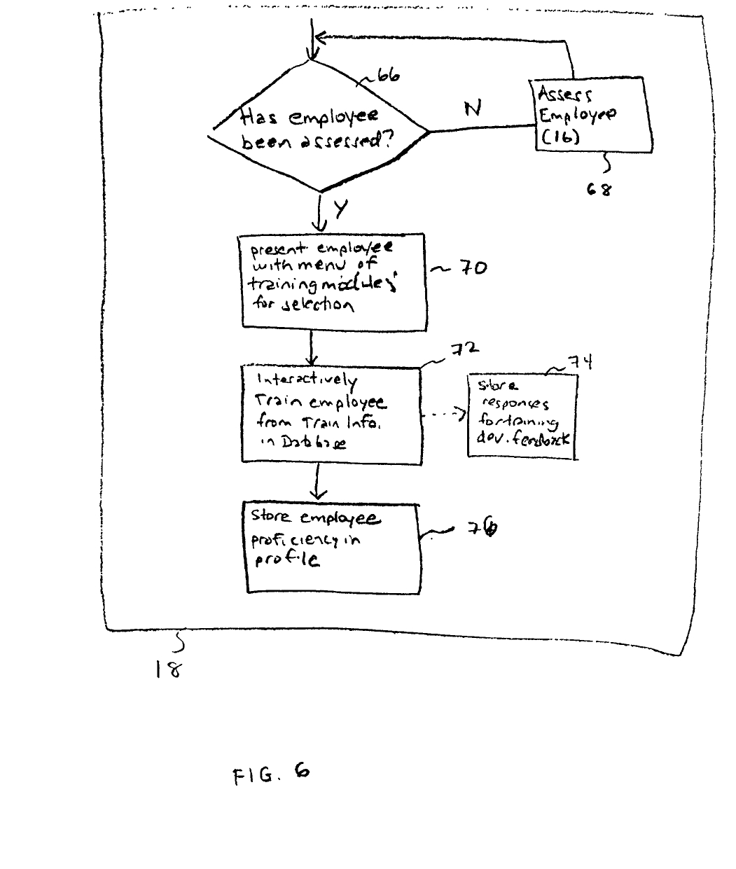

Referring to FIGS. 5A-5C, one implementation of the training system 10 uses “hyperlinks” to enable employees to quickly navigate through training system functions. As shown, in FIG. 5A, a central home page may offer hyperlinks to a training assessment menu 110, a library of training materials 112, and a list of training contacts 114. Selecting a hyperlink advances an employee to the selected function. For example, selecting the training assessment hyperlink 100, the system 10 can display the training assessment menu of FIG. 5B.

As shown in FIG. 5B, the assessment page enables employees to access an on-line assessment questionnaire in a variety of areas such as complying with antitrust laws 116 and ethical business practices 122. Selecting a link navigates a user to the corresponding on-line assessment questionnaire.

As shown in FIGS. 5C, an assessment questionnaire includes different questions 120 and possible responses 118. As shown, the questionnaires use graphical user interface controls (e.g., buttons and check boxes) to receive user responses 118. Assessment software 16 processes the entered responses and consults the assessment data 24 to determine training suited for an employee.

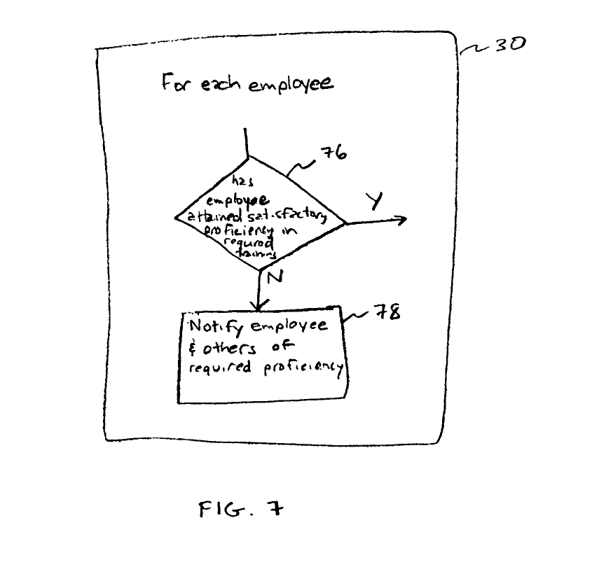

Referring to FIG. 6, when an employee 12 accesses the training system 10, the system 10 can determine (66) whether the employee's 12 training needs were previously assessed. If not, the system 10 can initiate (68) an assessment session. Otherwise, the system 10 can display (70) a menu listing training sessions for which the employee 12 has not yet attained an adequate level of proficiency. The training system 14 can also display a master menu of all available training sessions for employees eager to develop skills beyond their current job requirements.

After selecting a training session, training software 18 uses training information 38 to provide (72) interactive computer-based training and testing to an employee. The computer-based instruction typically includes multimedia presentations or animated computer graphics that explain different concepts followed by questions regarding the concepts. The computer-based instruction can provide appropriate feedback based on different answers to questions and respond to problems with additional explanation.

As noted, different employees may be required to attain different levels of proficiency in a subject. The training software can skip in-depth training for employees who need only generally awareness of a topic, but explore subjects more fully for employees that must exhibit mastery.

After interactive training (74) the training software 18 can record the employee's proficiency in answering questions in the employee's profile. Additionally, the training software can download or initiate shipment of additional training materials such as printed manuals or instructional videos to the employee.

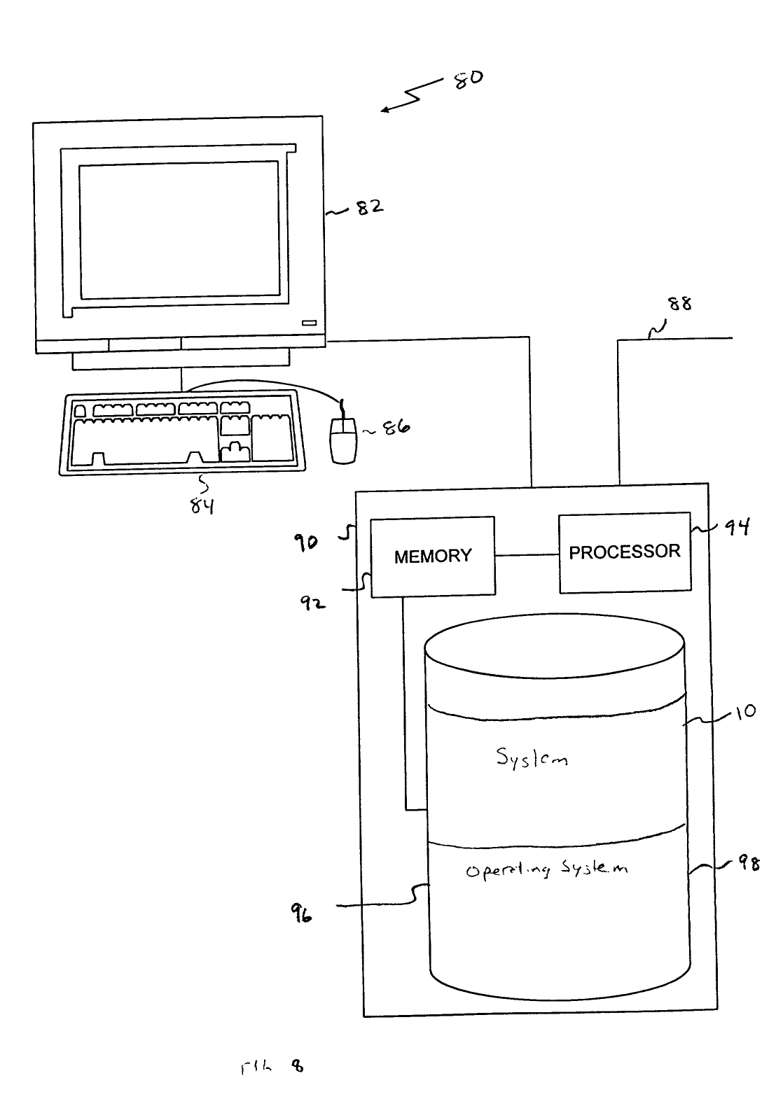

Referring to FIG. 7, compliance management software 30 provides management with a quick snapshot of an employee's training progress by comparing the level of proficiency attained by an employee with the required level. The compliance management 30 software may also notify management via e-mail when an employee has achieved sufficient proficiency in a subject or failed to do so after repeated attempts or within a predetermined timeframe.

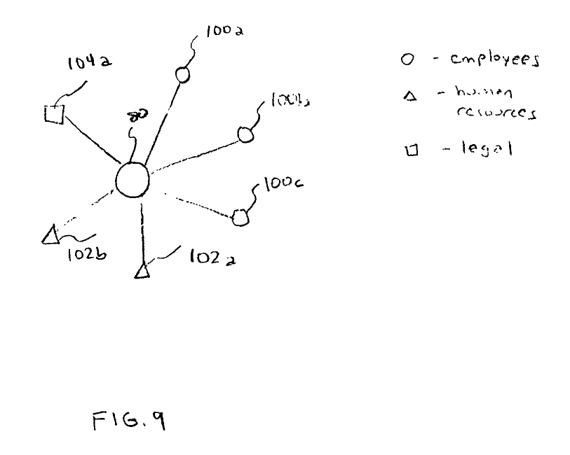

Referring to FIG. 8, though the system uses a client/server architecture, a single computer platform 80 can act as both client and server. The computer platform 80 includes a monitor 82 and input devices 84, 86 that display and permit interaction with the graphic user interface 14 provided by the training system 10. The computer platform 80 includes a digital computer 90 that connects a processor 94 to memory 90 and a mass storage device 96 (e.g., a hard drive, CD-ROM, and floppy disk). The mass storage device 96 stores the system 14 data and software instructions and, typically, an operating system such as Microsoft Windows 95®. During operation, the digital computer 90 transfers system 14 data and instructions to memory and the processor. Of course, the system 14 could be implemented in firmware or hardware, rather than software as described above. The computer platform 80 preferably offers a network connection 88 that can transmit and receive information from other computer platforms.

Referring to FIG. 9, the computer platform 80 can form part of a network of computers 100a-c, 102a-b, 104a connecting different business employees. As shown, the network forms a business intranet though any type of network (e.g., WAN, LAN, Internet) can provide the necessary communication between the server 80 and other computers 100a-c, 102a-b, 104a. The training system 10, preferably, offers information as HTML web-pages or Java applets, enabling network browsers such as Netscape Communicator® to provide a uniform and familiar user interface. The system 10 can also download information for execution by a destination system independent of the training system 10.

Other embodiments are within the scope of the following claims.

What is claimed is:

1. A computer-based method for use in managing training of employees, comprising:
storing data that correlate employee characteristics with training requirements;
obtaining information about employee characteristics by computer interaction with the employees; and
determining training schedules by applying the obtained information to the stored data.

2. The computer-based method of claim 1, wherein computer interaction comprises interaction via a user interface.

3. The computer-based method of claim 1, wherein computer interaction comprises processing at least one of the following: HTML instructions and Java instructions.

4. The computer-based method of claim 1, further comprising providing training indicated by the determined training schedule.

5. The computer-based method of claim 4, wherein the training comprises interactive computer-based training.

6. The computer-based method of claim 1, further comprising storing the determined training schedule.

7. The computer-based method of claim 1, wherein the determined training schedule comprises data representing a level of required proficiency.

8. The computer-based method of claim 1, further comprising storing data representing the proficiency attained by an employee.

9. The computer-based program method of claim 8, further comprising determining employee compliance with the determined training schedule.

10. A computer program product for use in managing training of employees, the computer program product disposed on a computer readable medium and comprising instructions for causing a computer to:
store data that correlate employee characteristics with training requirements;
obtain information about employee characteristics by computer interaction with the employees; and
determine training schedules by applying the obtained information to the stored data.

11. The computer program product of claim 10, wherein computer interaction comprises interaction via a user interface.

12. The computer program product of claim 10, wherein computer interaction comprises processing at least one of the following: HTML and Java instructions.

13. The computer program product of claim 10, further comprising instructions that provide training indicated by the determined training schedule.

14. The computer program product of claim 13, wherein the training comprises interactive computer-based training.

15. The computer program product of claim 10, further comprising instructions that store the determined training schedule.

16. The computer program product of claim 10, wherein the determined training schedule comprises data representing a level of required proficiency.

17. The computer program product of claim 10, further comprising instructions that store data representing the proficiency attained by an employee.

18. The computer program product of claim 17, further comprising instructions that determine employee compliance with the determined training schedule.

19. A computer-based method for use in managing training of employees whose job functions entail liability risks to their employer, comprising:
storing data identifying types of the liability risks;
storing with the data identifying each of the liability risks, data representing types of job functions that entail the associated risk,
interactively obtaining information about the employees job functions, and
managing training for the employees based on applying the interactively obtained information to the stored data.

20. The computer-based method of claim 19, wherein managing training comprising determining a training schedule.

21. The computer-based method of claim 19, wherein managing training comprises providing interactive computer-based training.

22. The computer-based method of claim 20, wherein managing training comprises determining employee compliance with the determined training schedule.

23. The computer-based method of claim 19, wherein types of risk comprise at least one of the following:
antitrust liability, insider trading, and ethical business practices.

24. The computer-based method of claim 19, wherein the job functions comprise at least one of the following:
pricing decisions and client contact.
